(19) United States
(12) Patent Application Publication
(10) Pub. No.: US 2025/0053687 A1
(43) Pub. Date: Feb. 13, 2025

(54) SYSTEMS AND METHODS FOR MODULATING OUTPUTS OF LARGE LANGUAGE MODELS RESPONSIVE TO CONFIDENTIAL INFORMATION

(71) Applicant: BeeKeeperAI, Inc., Austin, TX (US)

(72) Inventors: Michael Scott Blum, Scottsdale, AZ (US); Mary Elizabeth Chalk, Austin, TX (US); Robert Deward Rogers, Oakland, CA (US); Alan Donald Czeszynski, Pleasanton, CA (US); Sudish Mogli, San Jose, CA (US)

(21) Appl. No.: 18/798,100

(22) Filed: Aug. 8, 2024

Related U.S. Application Data
(60) Provisional application No. 63/519,133, filed on Aug. 11, 2023.

(51) Int. Cl. G06F 21/62; G06N 3/098

(52) U.S. Cl. CPC G06F 21/6254; G06N 3/098

(57) ABSTRACT

Systems and methods for the generation and usage of an identifier determiner model is provided. The identifier determiner model is generated in a sequestered computing node by receiving an untrained foundational model and a data set. The data set is bifurcated into a raw set and a de-identified set. The untrained foundational model is then tuned using the de-identified set to generate a sanitized model and the raw set to generate a raw model. Queries are presented to the raw model and the sanitized model to generate outputs. The identifier determiner machine learning model is generated by using the outputs to classify information as either sensitive or non-sensitive. The system may then receive a new foundational model. The identifier determiner machine learning model may be applied to outputs of this new foundational model to filter out sensitive information, either through redaction, or preventing them from being asked.

### CROSS REFERENCE TO RELATED APPLICATION

This Application (Attorney Docket No. BKP-2305-US) claims the benefit and priority of U.S. Provisional Application No. 63/519,133 (Attorney Docket No. BKP-2305-P), filed on Aug. 11, 2023, entitled “SYSTEMS AND METHODS FOR MODULATING OUTPUTS OF LARGE LANGUAGE MODELS RESPONSIVE TO CONFIDENTIAL INFORMATION”, the contents of which are incorporated herein in its entirety by this reference.

### BACKGROUND

The present invention relates in general to the field of confidential computing, and more specifically to methods, computer programs and systems for the operation of Large Language Models (LLMs) within a confidential computing environment. Such systems and methods are particularly useful in situations where algorithm developers wish to maintain the secrecy of their algorithms, and the data being processed is highly sensitive, such as protected health information. For the avoidance of doubt, an algorithm may include a model, code, pseudo-code, source code, or the like.

Within certain fields, there is a distinguishment between the developers of algorithms (often machine learning of artificial intelligence algorithms), and the stewards of the data that said algorithms are intended to operate with and be trained by. On its surface this seems to be an easily solved problem of merely sharing either the algorithm or the data that it is intended to operate with. However, in reality, there is often a strong need to keep the data and the algorithm secret. For example, the companies developing their algorithms may have the bulk of their intellectual property tied into the software comprising the algorithm. For many of these companies, their entire value may be centered in their proprietary algorithms. Sharing such sensitive data is a real risk to these companies, as the leakage of the software base code could eliminate their competitive advantage overnight.

One could imagine that instead, the data could be provided to the algorithm developer for running their proprietary algorithms and generation of the attendant reports. However, the problem with this methodology is two-fold. Firstly, often the datasets for processing and extremely large, requiring significant time to transfer the data from the data steward to the algorithm developer. Indeed, sometimes the datasets involved consume petabytes of data. The fastest fiber optics internet speed in the US is 2,000 MB/second. At this speed, transferring a petabyte of data can take nearly seven days to complete. It should be noted that most commercial internet speeds are a fraction of this maximum fiber optic speed.

The second reason that the datasets are not readily shared with the algorithm developers is that the data itself may be secret in some manner. For example, the data could also be proprietary, being of a significant asset value. Moreover, the data may be subject to some control or regulation. This is particularly true in the case of medical information. Protected health information, or PHI, for example, is subject to a myriad of laws, such as HIPAA, that include strict requirements on the sharing of PHI, and are subject to significant fines if such requirements are not adhered to.

Healthcare related information is of particular focus of this application. Of all the global stored data, about 30% resides in healthcare. This data provides a treasure trove of information for algorithm developers to train their specific algorithm models (AI or otherwise), and allows for the identification of correlations and associations within datasets. Such data processing allows advancements in the identification of individual pathologies, public health trends, treatment success metrics, and the like. Such output data from the running of these algorithms may be invaluable to individual clinicians, healthcare institutions, and private companies (such as pharmaceutical and biotechnology companies). At the same time, the adoption of clinical AI has been slow. More than 12,000 life-science papers described AI and ML in 2019 alone. Yet the U.S. Food and Drug Administration (FDA) has only approved only slightly more than 30 AI/ML-based medical technologies to date. Data access is a major barrier to clinical approval. The FDA requires proof that a model works across the entire population. However, privacy protections make it challenging to access enough diverse data to accomplish this goal.

Recently there has been a growing interest in Large Language Models (LLMs) as query tools to collect information from a dataset and yield surprisingly powerful results. An example of an LLM includes Chat GTP and the like. These LLMs consume a query, typically as an unstructured free-form text inquiry, and produce an output text (or sometimes abstracted visual output) that is responsive to the input query. A key architecture component of most foundational models is the Transformer, which serves to identify the relevant context for answering each query. For example, a typical Large Language Model (LLM) might have hundreds of Transformers, each of which detects different kinds of context, such as the importance of nearby words in a sentence or the main topic of a preceding paragraph. Such context awareness gives the model the ability to disambiguate words and concepts and to track ongoing themes. For the remainder of this disclosure, the terms LLM and foundational model may be utilized interchangeably. It should be noted that while these terms are considered synonymous, foundational models generally also contemplate models that convert text to images, images to text, images to images and text to text. The term “image” as used herein may include static images, or video recordings (with or without attendant audio portions). “Text” includes not just written text, but audio files as well.

LLMs utilize large corpuses of materials to be properly trained. In the process of such training, however, information from the training materials is often ingested and maintained/memorized within the model weights. This leads to the issue of particular sensitive information, such as PHI, being consumed as part of a training exercise, and being regurgitated by the LLM later in response to a query. This form of data exfiltration can be extremely problematic from a contractual and regulatory perspective.

Given that there is great value in the operation of secret algorithms, including LLMs, on data that also must remain secret, there is a significant need for systems and methods that allow for such confidential computing operations. These zero trust environments allow LLMs to be trained to not include/memorize PHI or other secret data, and/or prevents the LLM in operation from producing secret data to an outside party. Such systems and methods allow LLMs to operate in sectors where traditionally they were unable to be deployed.

### SUMMARY

The present systems and methods relate to the usage of foundational models on health care information including sensitive data, and the leveraging of identifier models to detect the presence of said sensitive data. Such identifier detector models may prevent the exfiltration of the sensitive data and/or selective exposure of such data based upon context.

In some embodiments an identifier determiner model is generated in a sequestered computing node by receiving an untrained large language model (LLM) or other foundational model and a data set. The data set is bifurcated into a raw set and a de-identified set. The untrained LLM is then tuned using the de-identified set to generate a sanitized model and the raw set to generate a raw model.

Queries are presented to the raw model and the sanitized model to generate outputs. The identifier determiner machine learning model is generated by using the outputs to classify information as either sensitive or non-sensitive. Sometimes a plurality of identifier determiner machine learning models may be collected in this manner and used to train a unified identifier determiner model using federated training.

The system may then receive a new foundational model. The identifier determiner machine learning model may be applied to outputs of this new foundational model to filter out sensitive information, either through redaction, or through preventing prohibited queries from being asked of the foundational model in the first place using a query sanitization model. The query sanitization machine learning model rejects queries or may provide alternate queries when a query is rejected.

In some embodiments, a weight AI model, comprised of contextual weights, may be generated based upon feedback from the identifier determiner machine learning model. The weigh AI model may be applied to the untrained foundational model to tune weights based upon contextual indicators to generate a contextually sensitive foundational model, which may be deployed.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIGS. 1A and 1B are example block diagrams of a system for zero trust computing of data by an algorithm, in accordance with some embodiment;

FIG. 2 is an example block diagram showing the core management system, in accordance with some embodiment;

FIG. 3 is an example block diagram showing a first model for the confidential computing data flow, in accordance with some embodiment;

FIG. 4 is an example block diagram showing a model for the confidential computing data flow with the generation of an identifier determiner model, in accordance with some embodiment;

FIG. 5 is an example block diagram showing a runtime server, in accordance with some embodiment;

FIG. 6 is a flowchart for an example process for the operation of the confidential computing data processing system, in accordance with some embodiment;

FIG. 7A a flowchart for an example process of acquiring and curating data, in accordance with some embodiment;

FIG. 7B a flowchart for an example process of onboarding a new host data steward, in accordance with some embodiment;

FIG. 8 is a flowchart for an example process of encapsulating the algorithm and data, in accordance with some embodiment;

FIG. 9 is a flowchart for an example process of a first model of algorithm encryption and handling, in accordance with some embodiment;

FIG. 10 is a flowchart for an example process of a second model of algorithm encryption and handling, in accordance with some embodiments;

FIG. 11 is a flowchart for an example process of a third model of algorithm encryption and handling, in accordance with some embodiments;

FIG. 12 is an example block diagram showing the training of the model within a zero-trust environment, in accordance with some embodiments;

FIG. 13 is a flowchart for an example process of training of the model within a zero-trust environment, in accordance with some embodiments;

FIG. 14 is an example block diagram for the system of generating an identifier determiner model, in accordance with some embodiments;

FIG. 15 is a flow diagram for the example process of generating an identifier determiner model, in accordance with some embodiments;

FIG. 16 is an example block diagram for the system of generating a query sanitization model, in accordance with some embodiments;

FIG. 17 is a flow diagram for the example process of generating a query sanitization model, in accordance with some embodiments;

FIG. 18 is an example block diagram for the system of generating and deploying a trained contextual foundational model, in accordance with some embodiments;

FIG. 19 is a flow diagram for the example process of generating and deploying a trained contextual foundational model, in accordance with some embodiments;

FIGS. 20A and 20B are alternate flow diagrams for the example process of training a contextually sensitive foundational model, in accordance with some embodiments;

FIGS. 21A and 21B are alternate flow diagrams for the example process of deploying the trained contextually sensitive foundational model, in accordance with some embodiments; and

FIGS. 22A and 22B are illustrations of computer systems capable of implementing the confidential computing, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

The present invention relates to systems and methods for the confidential computing application on one or more algorithms processing sensitive datasets. Such systems and methods may be applied to any given dataset, but may have particular utility within the healthcare setting, where the data is extremely sensitive. As such, the following descriptions will center on healthcare use cases. This particular focus, however, should not artificially limit the scope of the invention. For example, the information processed may include sensitive industry information, financial, payroll or other personally identifiable information, or the like. As such, while much of the disclosure will refer to protected health information (PHI) it should be understood that this may actually refer to any sensitive type of data. Likewise, while the data stewards are generally thought to be a hospital or other healthcare entity, these data stewards may in reality be any entity that has and wishes to process their data within a zero-trust environment.

In some embodiments, the following disclosure will focus upon the term “algorithm”. It should be understood that an algorithm may include machine learning (ML) models, neural network models, or other artificial intelligence (AI) models. However, algorithms may also apply to more mundane model types, such as linear models, least mean squares, or any other mathematical functions that convert one or more input values, and results in one or more output models. In particular, much of this disclosure will focus upon a subset of algorithms known as Large Language Models (LLMs) which may also be referred to as “Foundational Models.” While attention is focused upon this subset of ML algorithms, to the extent possible, references to LLMs or foundational models should be interpreted to include LLM hybrids and other classes of ML models alone or in combination with LLMs.

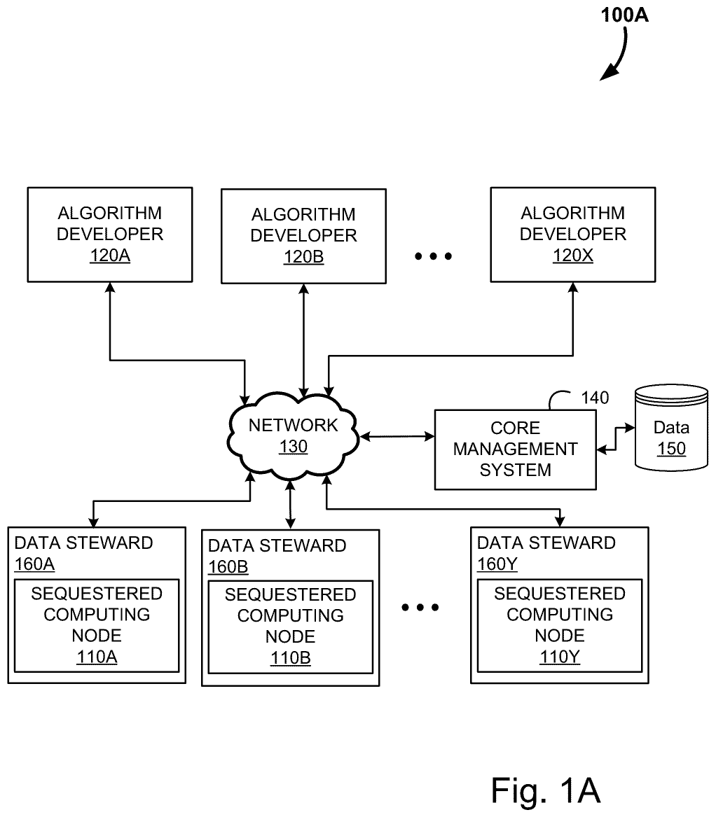

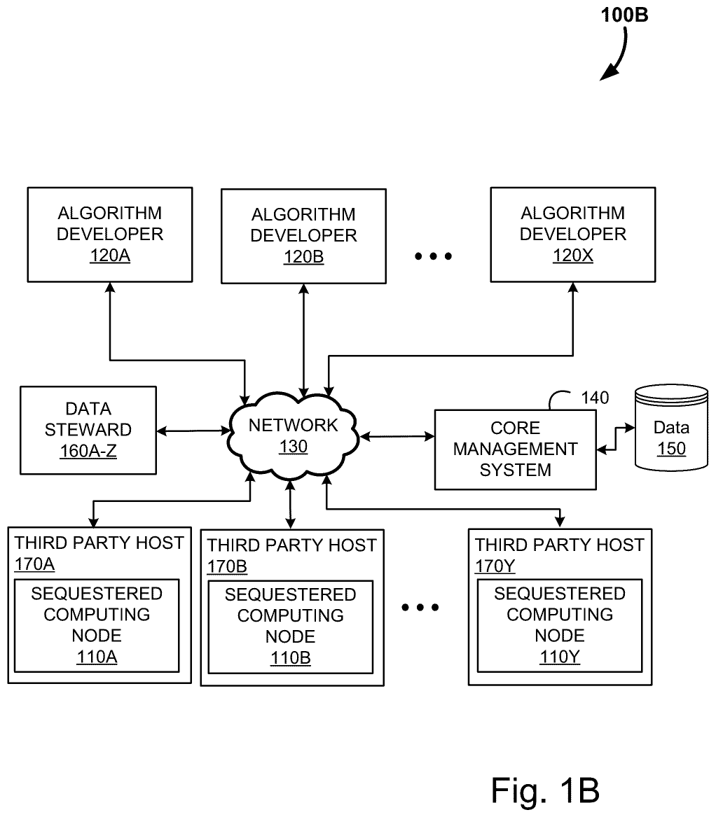

Also, in some embodiments of the disclosure, the terms “node”, “infrastructure” and “enclave” may be utilized. These terms are intended to be used interchangeably and indicate a computing architecture that is logically distinct (and often physically isolated). In no way does the utilization of one such term limit the scope of the disclosure, and these terms should be read interchangeably. To facilitate discussions, FIG. 1A is an example of a confidential computing infrastructure, shown generally at 100a. This infrastructure includes one or more algorithm developers 120a-x which generate one or more algorithms for processing of data, which in this case is held by one or more data stewards 160a-y. The algorithm developers are generally companies that specialize in data analysis, and are often highly specialized in the types of data that are applicable to their given models/algorithms. However, sometimes the algorithm developers may be individuals, universities, government agencies, or the like. By uncovering powerful insights in vast amounts of information, AI and machine learning (ML) can improve care, increase efficiency, and reduce costs. For example, AI analysis of chest x-rays predicted the progression of critical illness in COVID-19. In another example, an image-based deep learning model developed at MIT can predict breast cancer up to five years in advance. And yet another example is an algorithm developed at University of California San Francisco, which can detect pneumothorax (collapsed lung) from CT scans, helping prioritize and treat patients with this life-threatening condition—the first algorithm embedded in a medical device to achieve FDA approval.

Likewise, the data stewards may include public and private hospitals, companies, universities, banks and other financial institutions, governmental agencies, or the like. Indeed, virtually any entity with access to sensitive data that is to be analyzed may be a data steward.

The generated algorithms are encrypted at the algorithm developer in whole, or in part, before transmitting to the data stewards, in this example ecosystem. The algorithms are transferred via a core management system 140, which may supplement or transform the data using a localized datastore 150. The core management system also handles routing and deployment of the algorithms. The datastore may also be leveraged for key management in some embodiments that will be discussed in greater detail below.

Each of the algorithm developer 120a-x , and the data stewards 160a-y and the core management system 140 may be coupled together by a network 130. In most cases the network is comprised of a cellular network and/or the internet. However, it is envisioned that the network includes any wide area network (WAN) architecture, including private WAN's, or private local area networks (LANs) in conjunction with private or public WANs.

In this particular system, the data stewards maintain sequestered computing nodes 110a-y which function to actually perform the computation of the algorithm on the dataset. The sequestered computing nodes, or “enclaves”, may be physically separate computer server systems, or may encompass virtual machines operating within a greater network of the data steward's systems. The sequestered computing nodes should be thought of as a vault. The encrypted algorithm and encrypted datasets are supplied to the vault, which is then sealed. Encryption keys 390 unique to the vault are then provided, which allows the decryption of the data and models to occur. No party has access to the vault at this time, and the algorithm is able to securely operate on the data. The data and algorithms may then be destroyed, or maintained as encrypted, when the vault is “opened” in order to access the report/output derived from the application of the algorithm on the dataset. Due to the specific sequestered computing node being required to decrypt the given algorithm(s) and data, there is no way they can be intercepted and decrypted. This system relies upon public-private key techniques, where the algorithm developer utilizes the public key 390 for encryption of the algorithm, and the sequestered computing node includes the private key in order to perform the decryption. In some embodiments, the private key may be hardware (in the case of Azure, for example) or software linked (in the case of AWS, for example). In other embodiments, the algorithm may be encrypted using a symmetric key, and the symmetric key may be wrapped encrypted by a public key. Specifically, the algorithm developer has their own symmetrical key (content encryption key) used to encrypt the algorithm. The algorithm developer uses the public key to encrypt or “wrap” the content encryption key. The unwrapping occurs in the vault using the private half of the key, to then enable the content encryption key to decrypt the algorithm.

In some particular embodiments, the system sends algorithm models via an Azure Confidential Computing environment to a data steward's environment. Upon verification, the model and the data entered the Intel SGX sequestered enclave where the model is able to be validated against the protected information, for example PHI, data sets. Throughout the process, the algorithm owner cannot see the data, the data steward cannot see the algorithm model, and the management core can see neither the data nor the model. It should be noted that an Intel SGX enclave is but one substantiation of a hardware enabled trusted execution environment. Other hardware and/or software enabled trusted execution environments may be readily employed in other embodiments.

The data steward uploads encrypted data to their cloud environment using an encrypted connection that terminates inside an Intel SGX-sequestered enclave. In some embodiments, the encrypted data may go into Blob storage prior to terminus in the sequestered enclave, where it is pulled upon as needed. Then, the algorithm developer submits an encrypted, containerized AI model which also terminates into an Intel SGX-sequestered enclave. A key management system in the management core enables the containers to authenticate and then run the model on the data within the enclave. The data steward never sees the algorithm inside the container and the data is never visible to the algorithm developer. Neither component leaves the enclave. After the model runs, in some embodiments the developer receives a performance report on the values of the algorithm's performance. Finally, the algorithm owner may request that an encrypted artifact containing information about validation results is stored for regulatory compliance purposes and the data and the algorithm are wiped from the system.

FIG. 1B provides a similar ecosystem 100b. This ecosystem also includes one or more algorithm developers 120a-x , which generate, encrypt and output their models. The core management system 140 receives these encrypted payloads, and in some embodiments, transforms or augments unencrypted portions of the payloads. The major difference between this substantiation and the prior figure, is that the sequestered computing node(s) 110a-y are present within a third-party host 170a-y. An example of a third-party host may include an offsite server such as Amazon Web Service (AWS) or similar cloud infrastructure. In such situations, the data steward encrypts their dataset(s) and provides them, via the network, to the third party hosted sequestered computing node(s) 110a-y. The output of the algorithm running on the dataset is then transferred from the sequestered computing node in the third-party, back via the network to the data steward (or potentially some other recipient).

In some specific embodiments, the system relies on a unique combination of software and hardware available through Azure Confidential Computing. The solution uses virtual machines (VMs) running on specialized Intel processors with Intel Software Guard Extension (SGX), in this embodiment, running in the third-party system. Intel SGX creates sequestered portions of the hardware's processor and memory known as “enclaves” making it impossible to view data or code inside the enclave. Software within the management core handles encryption, key management, and workflows.

In some embodiments, the system may be some hybrid between FIGS. 1A and 1B. For example, some datasets may be processed at local sequestered computing nodes, especially extremely large datasets, and others may be processed at third parties. Such systems provide flexibility based upon computational infrastructure, while still ensuring all data and algorithms remain sequestered and not visible except to their respective owners.

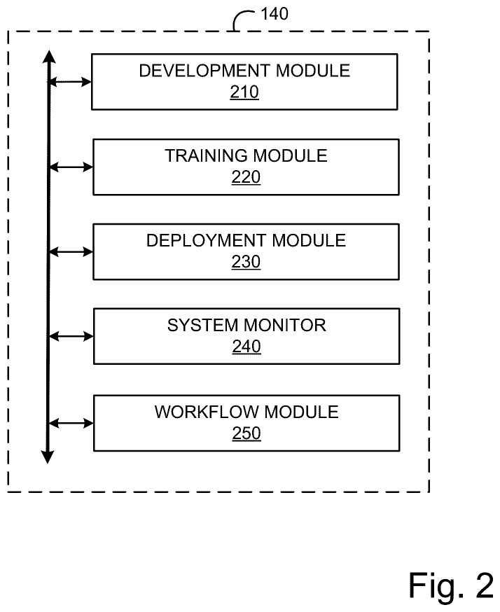

Turning now to FIG. 2, greater detail is provided regarding the core management system 140. The core management system 140 may include a data science development module 210, a data harmonizer workflow creation module 250, a software deployment module 230, a federated master algorithm training module 220, a system monitoring module 240, and a data store comprising global join data 240.

The data science development module 210 may be configured to receive input data requirements from the one or more algorithm developers for the optimization and/or validation of the one or more models. The input data requirements define the objective for data curation, data transformation, and data harmonization workflows. The input data requirements also provide constraints for identifying data assets acceptable for use with the one or more models. The data harmonizer workflow creation module 250 may be configured to manage transformation, harmonization, and annotation protocol development and deployment. The software deployment module 230 may be configured along with the data science development module 210 and the data harmonizer workflow creation module 250 to assess data assets for use with one or more models. This process can be automated or can be an interactive search/query process. The software deployment module 230 may be further configured along with the data science development module 210 to integrate the models into a sequestered capsule computing framework, along with required libraries and resources.

In some embodiments, it is desired to develop a robust, superior algorithm/model that has learned from multiple disjoint private data sets (e.g., clinical and health data) collected by data hosts from sources (e.g., patients). The federated master algorithm training module may be configured to aggregate the learning from the disjoint data sets into a single master algorithm. In different embodiments, the algorithmic methodology for the federated training may be different. For example, sharing of model parameters, ensemble learning, parent-teacher learning on shared data and many other methods may be developed to allow for federated training. The privacy and security requirements, along with commercial considerations such as the determination of how much each data system might be paid for access to data, may determine which federated training methodology is used.

The system monitoring module 240 monitors activity in sequestered computing nodes. Monitored activity can range from operational tracking such as computing workload, error state, and connection status as examples to data science monitoring such as amount of data processed, algorithm convergence status, variations in data characteristics, data errors, algorithm/model performance metrics, and a host of additional metrics, as required by each use case and embodiment.

In some instances, it is desirable to augment private data sets with additional data located at the core management system (join data 150). For example, geolocation air quality data could be joined with geolocation data of patients to ascertain environmental exposures. In certain instances, join data may be transmitted to sequestered computing nodes to be joined with their proprietary datasets during data harmonization or computation.

The sequestered computing nodes may include a harmonizer workflow module, harmonized data, a runtime server, a system monitoring module, and a data management module (not shown). The transformation, harmonization, and annotation workflows managed by the data harmonizer workflow creation module may be deployed by and performed in the environment by harmonizer workflow module using transformations and harmonized data. In some instances, the join data may be transmitted to the harmonizer workflow module to be joined with data during data harmonization. The runtime server may be configured to run the private data sets through the algorithm/model.

The system monitoring module monitors activity in the sequestered computing node. Monitored activity may include operational tracking such as algorithm/model intake, workflow configuration, and data host onboarding, as required by each use case and embodiment. The data management module may be configured to import data assets such as private data sets while maintaining the data assets within the pre-exiting infrastructure of the data stewards.

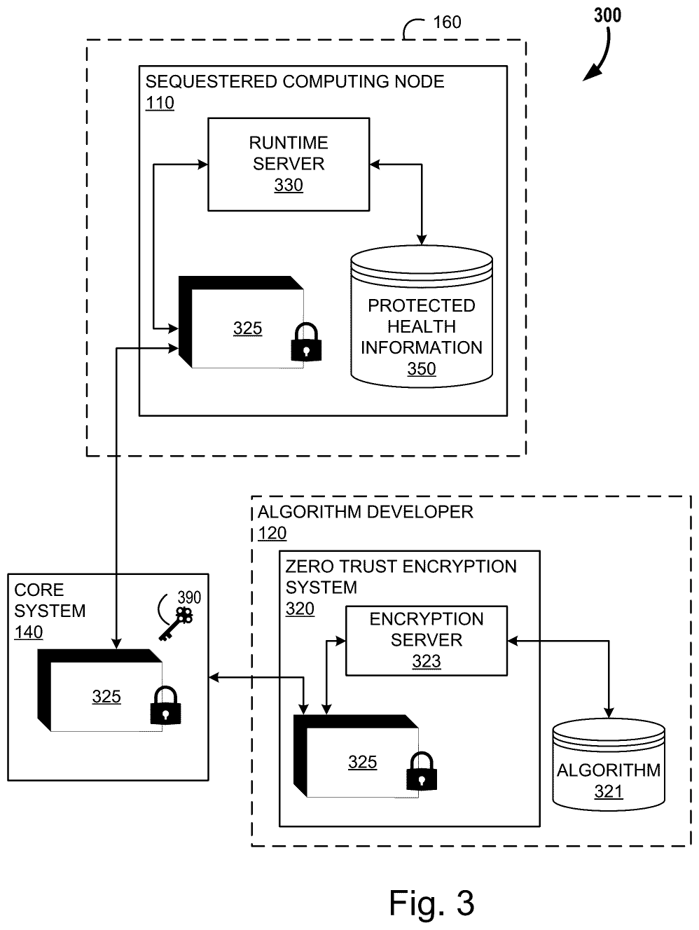

Turning now to FIG. 3, a first model of the flow of algorithms and data are provided, generally at 300. The Zero-Trust Encryption System 320 manages the encryption, by an encryption server 323, of all the algorithm developer's 120 software assets 321 in such a way as to prevent exposure of intellectual property (including source or object code) to any outside party, including the entity running the core management system 140 and any affiliates, during storage, transmission and runtime of said encrypted algorithms 325. In this embodiment, the algorithm developer is responsible for encrypting the entire payload 325 of the software using its own encryption keys. Decryption is only ever allowed at runtime in a sequestered capsule computing environment 110.

The core management system 140 receives the encrypted computing assets (algorithms) 325 from the algorithm developer 120. Decryption keys to these assets are not made available to the core management system 140 so that sensitive materials are never visible to it. The core management system 140 distributes these assets 325 to a multitude of data steward nodes 160 where they can be processed further, in combination with private datasets, such as protected health information (PHI) 350.

Each Data Steward Node 160 maintains a sequestered computing node 110 that is responsible for allowing the algorithm developer's encrypted software assets 325 (the “algorithm” or “algo”) to compute on a local private dataset 350 that is initially encrypted. Within data steward node 160, one or more local private datasets (not illustrated) is harmonized, transformed, and/or annotated and then this dataset is encrypted by the data steward, into a local dataset 350, for use inside the sequestered computing node 110.

The sequestered computing node 110 receives the encrypted software assets 325 and encrypted data steward dataset(s) 350 and manages their decryption in a way that prevents visibility to any data or code at runtime at the runtime server 330. In different embodiments this can be performed using a variety of secure computing enclave technologies, including but not limited to hardware-based and software-based isolation.

In this present embodiment, the entire algorithm developer software asset payload 325 is encrypted in a way that it can only be decrypted in an approved sequestered computing enclave/node 110. This approach works for sequestered enclave technologies that do not require modification of source code or runtime environments in order to secure the computing space (e.g., software-based secure computing enclaves).

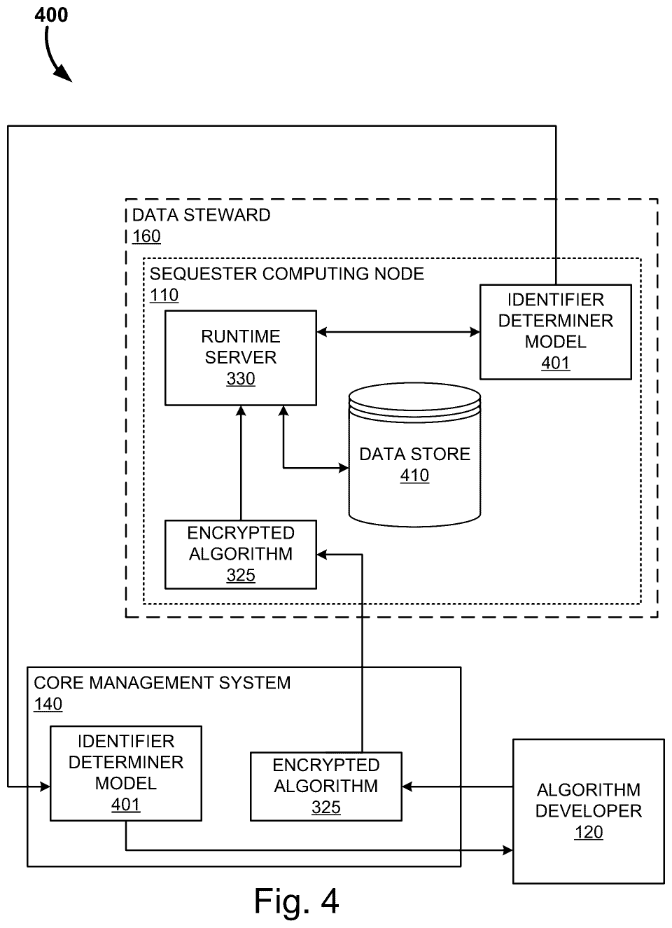

Turning to FIG. 4, the general environment is maintained, as seen generally at 400, however in this embodiment the flow of the IP assets is illustrated in greater detail. In this example diagram, the Algorithm developer 120 generates an algorithm, which is then encrypted and provided as an encrypted algorithm payload 325 to the core management system 140. In this embodiment, the algorithm may include a Large Language Model (LLM) otherwise referred to as a foundational model. As discussed previously, the core management system 140 is incapable of decrypting the encrypted algorithm 325. Rather, the core management system 140 controls the routing of the encrypted algorithm 325 and the management of keys. The encrypted algorithm 325 is then provided to the data steward 160 which is then “placed” in the sequestered computing node 110. The data steward 160 is likewise unable to decrypt the encrypted algorithm 325 unless and until it is located within the sequestered computing node 110, in which case the data steward still lacks the ability to access the “inside” of the sequestered computing node 110. As such, the algorithm is never accessible to any entity outside of the algorithm developer.

Likewise, the data steward 160 has access to protected health information and/or other sensitive information. The data steward 160 never is required to transfer this data outside of its ecosystem (an if it is, it may remain in an encrypted state) thus ensuring that the data is always inaccessible by any other party by virtue of it remaining encrypted when accessible by any other party. The sensitive data may be encrypted (or remain in the clear) as it is also transferred into the sequestered computing node 110. This data store 410 is made accessible to the runtime server 330 also located “inside” the sequestered computing node 110. The runtime server 330 decrypts the encrypted algorithm 325 to yield the underlying algorithm model. This algorithm may then use the data store 410 to generate inferences regarding the date contained in the data store 410 (not illustrated). These inferences have value for the data steward 110 as well as other interested parties and may be outputted to the data steward (or other interested parties such as researchers or regulators) for consumption. The runtime server 330 may likewise engage in training activities and, importantly, generate an identifier determiner model 401 as part of training an LLM. The identifier determiner model 401 is another ML model which predicts what information within the Data store 410 is considered PHI or other secret information. The identifier determiner model 401 may thus be leveraged by a number of parties to ensure the risk of data exfiltration is minimized (as will be discussed in a number of different embodiments below).

In some embodiments, the identifier determiner model 401 is generated by training the LLM using a ‘full’ dataset (including PHI) and also training the LLM on a de-identified data set. This de-identified data may include the removal of all identifiable/private data and/or replacement of the sensitive data with a hash or other place saver. By comparison of the outputs to a query between these two different models, it is possible to train a deep learning model on what constitutes “sensitive data”.

The identifier determiner model 401 may be maintained within the sequestered computing node 110 for downstream usage, and/or may be provided back to the core management system 140. The core management system 140 may provide the identifier determiner model 401 back to the algorithm developer 120 in some limited embodiments, or may transfer the identifier determiner model 401 to other interested parties (such as other sequestered computing nodes where additional operations are taking place).

The runtime server 330 may also perform a number of other operations, such as the generation of a performance model or the like. The performance model is a regression model generated based upon the inferences derived from the algorithm. The performance model provides data regarding the performance of the algorithm based upon the various inputs. The performance model may model for algorithm accuracy, F1 score, precision, recall, dice score, ROC (receiver operator characteristic) curve/area, log loss, Jaccard index, error, R² or by some combination thereof.

Once the algorithm developer 120 receives the performance model it may be decrypted, and leveraged to validate the algorithm and, importantly, may be leveraged to actively train the algorithm in the future. This may occur by identifying regions of the performance model that have lower performance ratings and identify attributes/variables in the datasets that correspond to these poorer performing model segments. The system then incorporates human feedback when such variables are present in a dataset to assist in generating a gold standard training set for these variable combinations. The performance model may then be trained based upon these gold standard training sets. Even without the generation of additional gold standard data, investigation of poorer performing model segments enables changes to the functional form of the model and testing for better performance. It is likewise possible that the inclusion of additional variables by the model allows for the distinction of attributes of a patient population. This is identified by areas of the model that has a lower performance which indicates that there is a fundamental issue with the model. An example is that a model operates well (has higher performance) for male patients as compared to female patients. This may indicate that different model mechanics may be required for female patient populations.

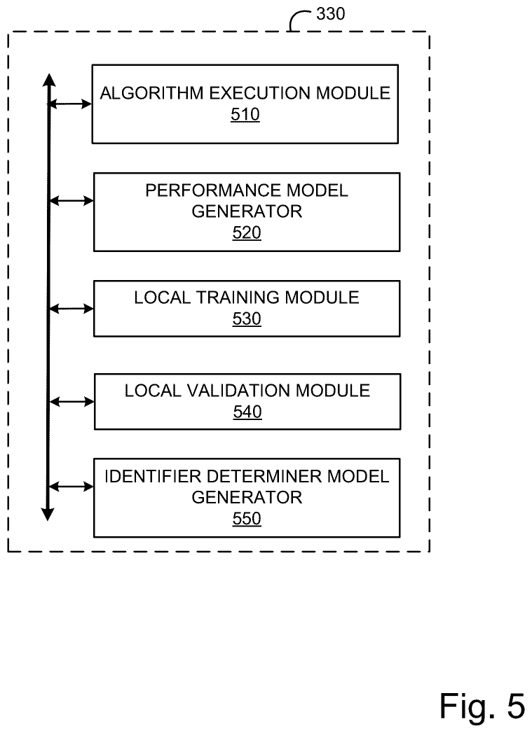

FIG. 5 provides a more detailed illustration of the functional components of the runtime server 330. An algorithm execution module 510 performs the actual processing of the PHI using the algorithm. The result of this execution includes the generation of discrete inferences.

The runtime server 330 includes the performance model generator 520 which receives outputs from the algorithm execution module 510 and generates the performance model using a recursion methodology as outlined above.

In some embodiments, the runtime server 330 may additionally execute a master algorithm and tune the algorithm locally at a local training module 530. Such localized training is known, however, in the present system, the local training module 530 is configured to take the locally tuned model and then reoptimize the master. The new reoptimized master may, in a reliable manner, be retuned to achieve performance that is better than the prior model's performance, yet staying consistent with the prior model. This consistency includes relative weighting of particular datapoints to ensure consistency in the models for these key elements while at the same time improving performance of the model generally.

In some embodiments, the confirmation that a retuned model is performing better than the prior version is determined by a local validation module 540. The local validation module 540 may include a mechanical test whereby the algorithm is deployed with a model specific validation methodology that is capable of determining that the algorithm performance has not deteriorated after a re-optimization. In some embodiments, the tuning may be performed on different data splits, and these splits are used to define a redeployment method. It should be noted that increasing the number (N) of samplings used for optimization not only improves the model's performance, but also reduces the size of the confidence interval.

Lastly, the runtime server 330 includes the identifier determiner model generator 550 which actually generates the identifier determiner model 401. The identifier determiner model generator 550 may operate in tandem with the local training module 530 to train the LLM algorithm (foundational model) using two discrete data splits: 1) a full dataset and 2) a de-identified data set. By comparison between the outputs of these two differently trained models, it is possible to train an additional model to detect when such a piece of sensitive information is present in the answer. This identifier determiner model 401 may be employed in a number of ways to prevent later data exfiltration events. For example the identifier determiner model 401 may be used to prefilter the incoming queries to an LLM to prevent any query that results in a data exfiltration event, or may be used to train foundational models that are context sensitive. These individual use cases will be discussed in greater detail in later figures and attendant descriptions.

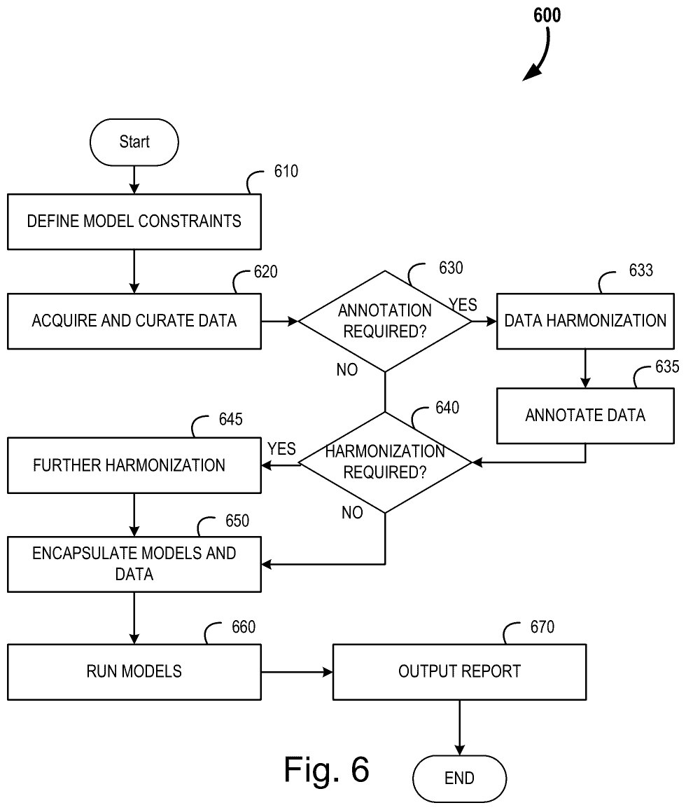

Turning to FIG. 6, one embodiment of the process for deployment and running of algorithms within the sequestered computing nodes is illustrated, at 600. Initially the algorithm developer provides the algorithm to the system. The at least one algorithm/model is generated by the algorithm developer using their own development environment, tools, and seed data sets (e.g., training/testing data sets). In some embodiments, the algorithms may be trained on external datasets instead, as will be discussed further below. The algorithm developer provides constraints (at 610) for the optimization and/or validation of the algorithm(s). Constraints may include any of the following: (i) training constraints, (ii) data preparation constraints, and (iii) validation constraints. These constraints define objectives for the optimization and/or validation of the algorithm(s) including data preparation (e.g., data curation, data transformation, data harmonization, and data annotation), model training, model validation, and reporting.

In some embodiments, the training constraints may include, but are not limited to, at least one of the following: hyperparameters, regularization criteria, convergence criteria, algorithm termination criteria, training/validation/test data splits defined for use in algorithm(s), and training/testing report requirements. A model hyper parameter is a configuration that is external to the model, and which value cannot be estimated from data. The hyperparameters are settings that may be tuned or optimized to control the behavior of a ML or AI algorithm and help estimate or learn model parameters.

Regularization constrains the coefficient estimates towards zero. This discourages the learning of a more complex model in order to avoid the risk of overfitting. Regularization, significantly reduces the variance of the model, without a substantial increase in its bias. The convergence criterion is used to verify the convergence of a sequence (e.g., the convergence of one or more weights after a number of iterations). The algorithm termination criteria define parameters to determine whether a model has achieved sufficient training. Because algorithm training is an iterative optimization process, the training algorithm may perform the following steps multiple times. In general, termination criteria may include performance objectives for the algorithm, typically defined as a minimum amount of performance improvement per iteration or set of iterations.

The training/testing report may include criteria that the algorithm developer has an interest in observing from the training, optimization, and/or testing of the one or more models. In some instances, the constraints for the metrics and criteria are selected to illustrate the performance of the models. For example, the metrics and criteria such as mean percentage error may provide information on bias, variance, and other errors that may occur when finalizing a model such as vanishing or exploding gradients. Bias is an error in the learning algorithm. When there is high bias, the learning algorithm is unable to learn relevant details in the data. Variance is an error in the learning algorithm, when the learning algorithm tries to over-learn from the dataset or tries to fit the training data as closely as possible. Further, common error metrics such as mean percentage error and R2score are not always indicative of accuracy of a model, and thus the algorithm developer may want to define additional metrics and criteria for a more in depth look at accuracy of the model.

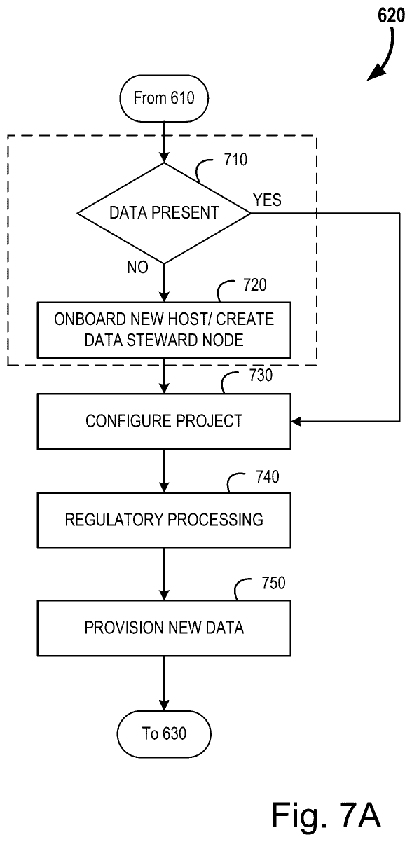

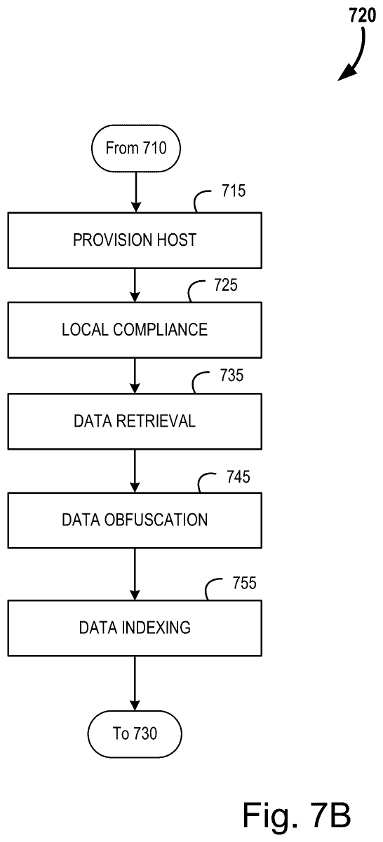

Next, data assets that will be subjected to the algorithm(s) are identified, acquired, and curated (at 620). FIG. 7A provides greater detail of this acquisition and curation of the data. Often, the data may include healthcare related data (PHI). Initially, there is a query if data is present (at 710). The identification process may be performed automatically by the platform running the queries for data assets (e.g., running queries on the provisioned data stores using the data indices) using the input data requirements as the search terms and/or filters. Alternatively, this process may be performed using an interactive process, for example, the algorithm developer may provide search terms and/or filters to the platform. The platform may formulate questions to obtain additional information, the algorithm developer may provide the additional information, and the platform may run queries for the data assets (e.g., running queries on databases of the one or more data hosts or web crawling to identify data hosts that may have data assets) using the search terms, filters, and/or additional information. In either instance, the identifying is performed using differential privacy for sharing information within the data assets by describing patterns of groups within the data assets while withholding private information about individuals in the data assets.

If the assets are not available, the process generates a new data steward node (at 720). The data query and onboarding activity (surrounded by a dotted line) is illustrated in this process flow of acquiring the data; however, it should be realized that these steps may be performed any time prior to model and data encapsulation (step 650 in FIG. 6). Onboarding/creation of a new data steward node is shown in greater detail in relation to FIG. 7B. In this example process a data host compute and storage infrastructure (e.g., a sequestered computing node as described with respect to FIGS. 1A-5) is provisioned (at 715) within the infrastructure of the data steward. In some instances, the provisioning includes deployment of encapsulated algorithms in the infrastructure, deployment of a physical computing device with appropriately provisioned hardware and software in the infrastructure, deployment of storage (physical data stores or cloud-based storage), or deployment on public or private cloud infrastructure accessible via the infrastructure, etc.

Next, governance and compliance requirements are performed (at 725). In some instances, the governance and compliance requirements include getting clearance from an institutional review board, and/or review and approval of compliance of any project being performed by the platform and/or the platform itself under governing law such as the Health Insurance Portability and Accountability Act (HIPAA). Subsequently, the data assets that the data steward desires to be made available for optimization and/or validation of algorithm(s) are retrieved (at 735). In some instances, the data assets may be transferred from existing storage locations and formats to provisioned storage (physical data stores or cloud-based storage) for use by the sequestered computing node (curated into one or more data stores). The data assets may then be obfuscated (at 745). Data obfuscation is a process that includes data encryption or tokenization, as discussed in much greater detail below. Lastly, the data assets may be indexed (at 755). Data indexing allows queries to retrieve data from a database in an efficient manner. The indexes may be related to specific tables and may be comprised of one or more keys or values to be looked up in the index (e.g., the keys may be based on a data table's columns or rows).

Returning to FIG. 7A, after the creation of the new data steward, the project may be configured (at 730). In some instances, the data steward computer and storage infrastructure is configured to handle a new project with the identified data assets. In some instances, the configuration is performed similarly to the process described of FIG. 7B. Next, regulatory approvals (e.g., IRB and other data governance processes) are completed and documented (at 740). Lastly, the new data is provisioned (at 750). In some instances, the data storage provisioning includes identification and provisioning of a new logical data storage location, along with creation of an appropriate data storage and query structure.

Returning now to FIG. 6, after the data is acquired and configured, a query is performed if there is a need for data annotation (at 630). If so, the data is initially harmonized (at 633) and then annotated (at 635). Data harmonization is the process of collecting data sets of differing file formats, naming conventions, and columns, and transforming it into a cohesive data set. The annotation is performed by the data steward in the sequestered computing node. A key principle to the transformation and annotation processes is that the platform facilitates a variety of processes to apply and refine data cleaning and transformation algorithms, while preserving the privacy of the data assets, all without requiring data to be moved outside of the technical purview of the data steward.

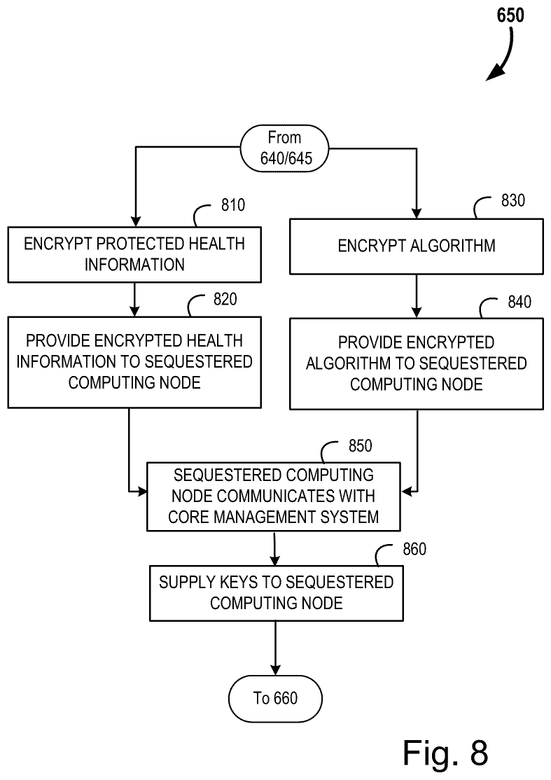

After annotation, or if annotation was not required, another query determines if additional data harmonization is needed (at 640). If so, then there is another harmonization step (at 645) that occurs in a manner similar to that disclosed above. After harmonization, or if harmonization isn't needed, the models and data are encapsulated (at 650). Data and model encapsulation is described in greater detail in relation to FIG. 8. In the encapsulation process the protected data, and the algorithm are each encrypted (at 810 and 830 respectively). In some embodiments, the data is encrypted either using traditional encryption algorithms (e.g., RSA) or homomorphic encryption.

Next the encrypted data and encrypted algorithm are provided to the sequestered computing node (at 820 and 840 respectively). There processes of encryption and providing the encrypted payloads to the sequestered computing nodes may be performed asynchronously, or in parallel. Subsequently, the sequestered computing node may phone home to the core management node (at 850) requesting the keys needed. These keys are then also supplied to the sequestered computing node (at 860), thereby allowing the decryption of the assets.

Returning again to FIG. 6, once the assets are all within the sequestered computing node, they may be decrypted and the algorithm may run against the dataset (at 660). The results from such runtime may be outputted as a report (at 670) for downstream consumption.

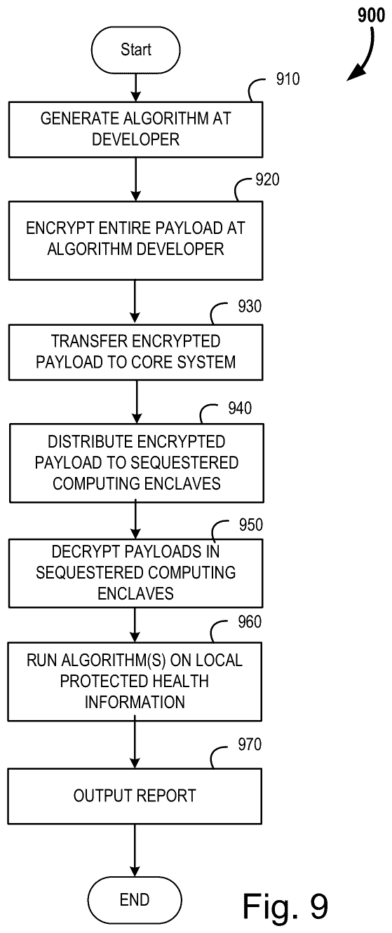

Turning now to FIG. 9, a first embodiment of the system for confidential computing processing of the data assets by the algorithm is provided, at 900. In this example process, the algorithm is initially generated by the algorithm developer (at 910) in a manner similar to that described previously. The entire algorithm, including its container, is then encrypted (at 920), using a public key, by the encryption server within the algorithm developer's infrastructure. The entire encrypted payload is provided to the core management system (at 930). The core management system then distributes the encrypted payload to the sequestered computing enclaves (at 940).

Likewise, the data steward collects the data assets desired for processing by the algorithm. This data is also provided to the sequestered computing node. In some embodiments, this data may also be encrypted. The sequestered computing node then contacts the core management system for the keys. The system relies upon public-private key methodologies for the decryption of the algorithm, and possibly the data (at 950).

After decryption within the sequestered computing node, the algorithm(s) are run (at 960) against the protected health information (or other sensitive information based upon the given use case). The results are then output (at 970) to the appropriate downstream audience (generally the data steward, but may include public health agencies or other interested parties).

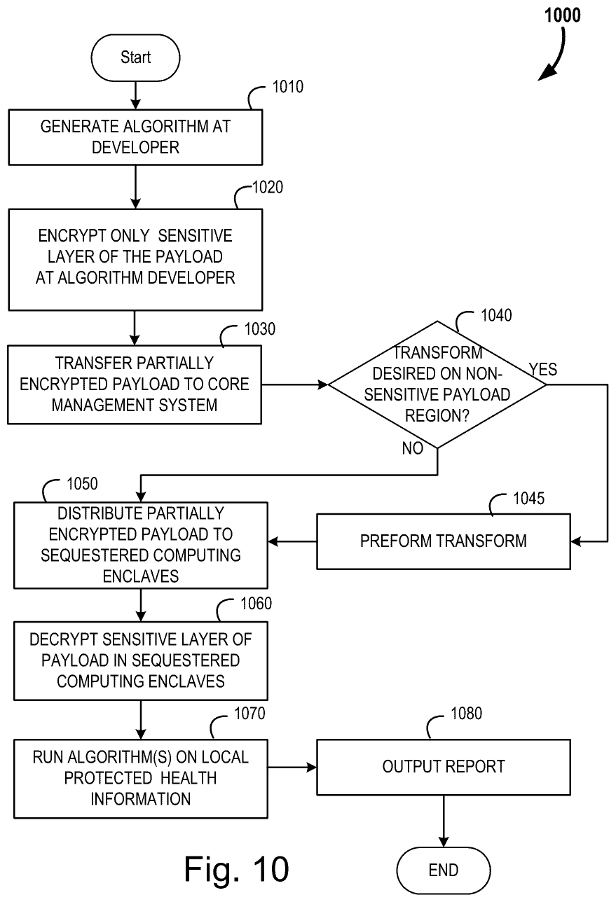

FIG. 10, on the other hand, provides another methodology of confidential computing that has the advantage of allowing some transformation of the algorithm data by either the core management system or the data steward themselves, shown generally at 1000. As with the prior embodiment, the algorithm is initially generated by the algorithm developer (at 1010). However, at this point the two methodologies diverge. Rather than encrypt the entire algorithm payload, it differentiates between the sensitive portions of the algorithm (generally the algorithm weights), and non-sensitive portions of the algorithm (including the container, for example). The process then encrypts only layers of the payload that have been flagged as sensitive (at 1020).

The partially encrypted payload is then transferred to the core management system (at 1030). At this stage a determination is made whether a modification is desired to the non-sensitive, non-encrypted portion of the payload (at 1040). If a modification is desired, then it may be performed in a similar manner as discussed previously (at 1045).

If no modification is desired, or after the modification is performed, the payload may be transferred (at 1050) to the sequestered computing node located within the data steward infrastructure (or a third party). Although not illustrated, there is again an opportunity at this stage to modify any non-encrypted portions of the payload when the algorithm payload is in the data steward's possession.

Next, the keys unique to the sequestered computing node are employed to decrypt the sensitive layer of the payload (at 1060), and the algorithms are run against the locally available protected health information (at 1070). In the use case where a third party is hosting the sequestered computing node, the protected health information may be encrypted at the data steward before being transferred to the sequestered computing node at said third party. Regardless of sequestered computing node location, after runtime, the resulting report is outputted to the data steward and/or other interested party (at 1080).

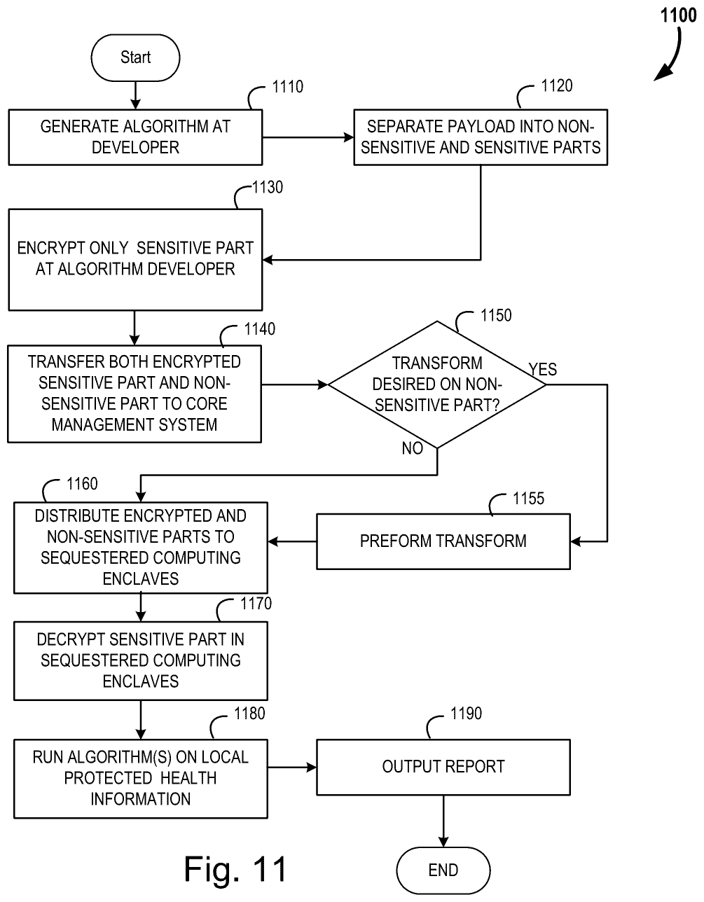

FIG. 11, as seen at 1100, is similar to the prior two figures in many regards. The algorithm is similarly generated at the algorithm developer (at 1110); however, rather than being subject to an encryption step immediately, the algorithm payload may be logically separated into a sensitive portion and a non-sensitive portion (at 1120). To ensure that the algorithm runs properly when it is ultimately decrypted in the (sequestered) sequestered computing enclave, instructions about the order in which computation steps are carried out may be added to the unencrypted portion of the payload.

Subsequently, the sensitive portion is encrypted at the algorithm developer (at 1130), leaving the non-sensitive portion in the clear. Both the encrypted portion and the non-encrypted portion of the payload are transferred to the core management system (at 1140). This transfer may be performed as a single payload, or may be done asynchronously. Again, there is an opportunity at the core management system to perform a modification of the non-sensitive portion of the payload. A query is made if such a modification is desired (at 1150), and if so it is performed (at 1155). Transformations may be similar to those detailed above.

Subsequently, the payload is provided to the sequestered computing node(s) by the core management system (at 1160). Again, as the payload enters the data steward node(s), it is possible to perform modifications to the non-encrypted portion(s). Once in the sequestered computing node, the sensitive portion is decrypted (at 1170), the entire algorithm payload is run (at 1180) against the data that has been provided to the sequestered computing node (either locally or supplied as an encrypted data package). Lastly, the resulting report is outputted to the relevant entities (at 1190).

Any of the above modalities of operation provide the instant confidential computing architecture with the ability to process a data source with an algorithm without the ability for the algorithm developer to have access to the data being processed, the data steward being unable to view the algorithm being used, or the core management system from having access to either the data or the algorithm. This uniquely provides each party the peace of mind that their respective valuable assets are not at risk, and facilitates the ability to easily, and securely, process datasets.

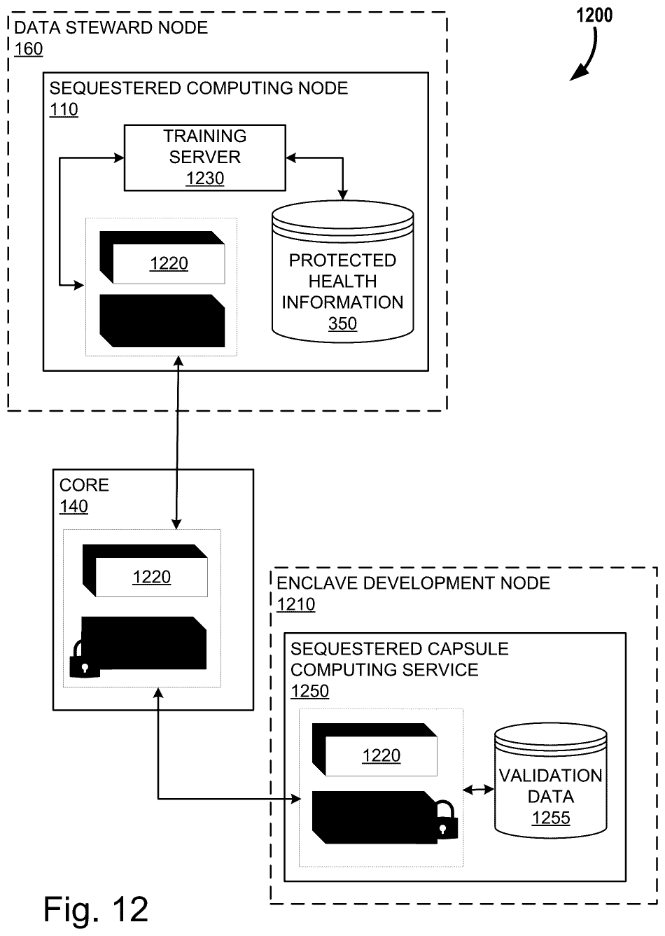

Turning now to FIG. 12, a system for confidential computing training of algorithms is presented, generally at 1200. Traditionally, algorithm developers require training data to develop and refine their algorithms. Such data is generally not readily available to the algorithm developer due to the nature of how such data is collected, and due to regulatory hurdles. As such, the algorithm developers often need to rely upon other parties (data stewards) to train their algorithms. As with running an algorithm, training the algorithm introduces the potential to expose the algorithm and/or the datasets being used to train it.

In this example system, the nascent algorithm is provided to the sequestered computing node 110 in the data steward node 160. This new, untrained algorithm may be prepared by the algorithm developer (not shown) and provided in the clear to the sequestered computing node 110 as it does not yet contain any sensitive data. The sequestered computing node leverages the locally available protected health information 350, using a training server 1230, to train the algorithm. This generates a sensitive portion of the algorithm 1225 (generally the weights and coefficients of the algorithm), and a non-sensitive portion of the algorithm 1220. As the training is performed within the sequestered computing node 110, the data steward 160 does not have access to the algorithm that is being trained. Once the algorithm is trained, the sensitive portion 1225 of the algorithm is encrypted prior to being released from the sequestered computing enclave 110. This partially encrypted payload is then transferred to the data management core 140, and distributed to a sequestered capsule computing service 1250, operating within an enclave development node 1210. The enclave development node is generally hosted by one or more data stewards.

The sequestered capsule computing node 1250 operates in a similar manner as the sequestered computing node 110 in that once it is “locked” there is no visibility into the inner workings of the sequestered capsule computing node 1250. As such, once the algorithm payload is received, the sequestered capsule computing node 1250 may decrypt the sensitive portion of the algorithm 1225 using a public-private key methodology. The sequestered capsule computing node 1250 also has access to validation data 1255. The algorithm is run against the validation data, and the output is compared against a set of expected results. If the results substantially match, it indicates that the algorithm is properly trained, if the results do not match, then additional training may be required.

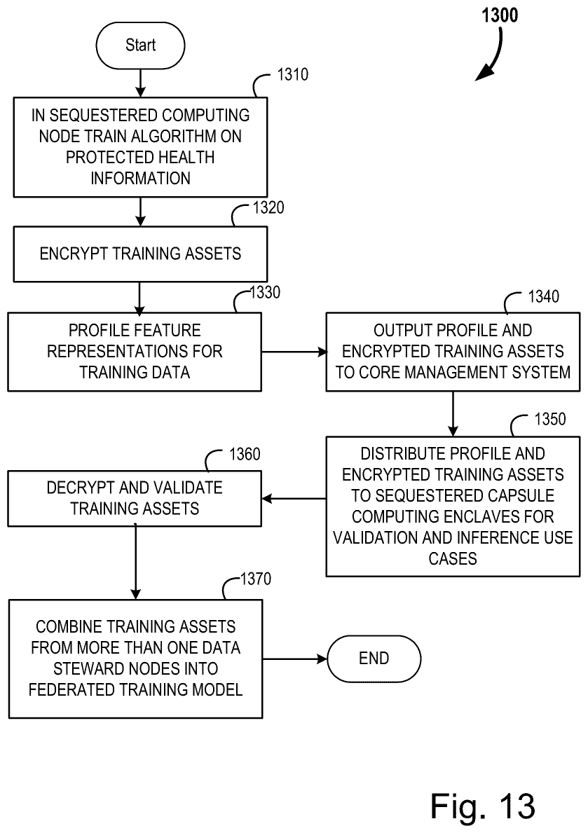

FIG. 13 provides the process flow, at 1300, for this training methodology. In the sequestered computing node, the algorithm is initially trained (at 1310). The training assets (sensitive portions of the algorithm) are encrypted within the sequestered computing node (at 1320). Subsequently the feature representations for the training data are profiled (at 1330). One example of a profiling methodology would be to take the activations of the certain AI model layers for samples in both the training and test set, and see if another model can be trained to recognize which activations came from which dataset. These feature representations are non-sensitive, and are thus not encrypted. The profile and the encrypted data assets are then output to the core management system (at 1340) and are distributed to one or more sequestered capsule computing enclaves (at 1350). At the sequestered capsule computing node, the training assets are decrypted and validated (at 1360). After validation the training assets from more than one data steward node are combined into a single featured training model (at 1370). This is known as federated training.

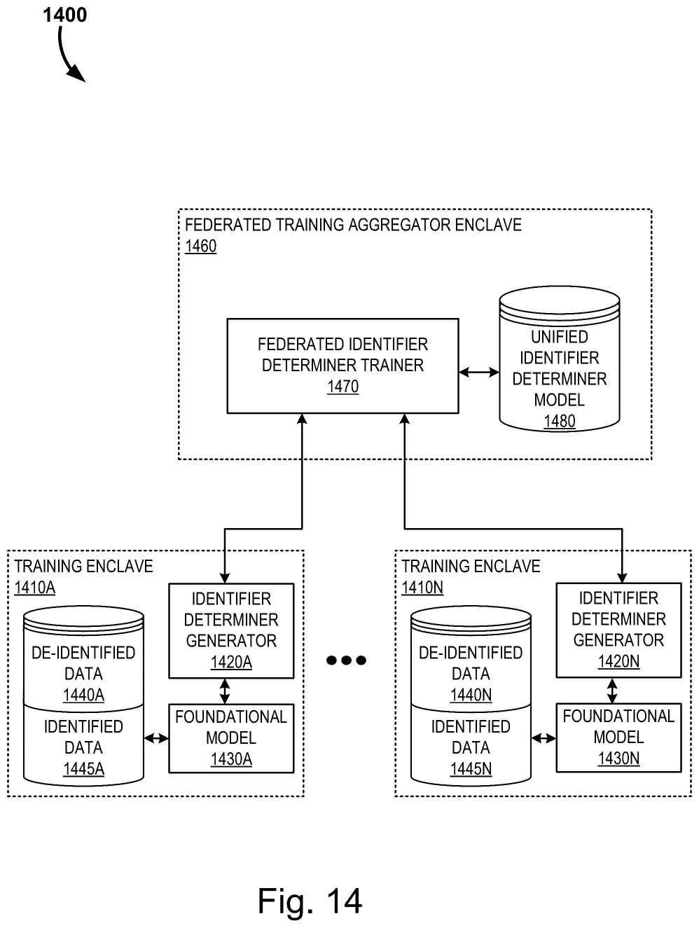

Turning now to FIG. 14 a more detailed example on the generation of an identifier determiner model is provided, shown generally at 1400. In this example block diagram, a series of training enclaves 1410a-n are shown. Each training enclave 1410a-n may be a dedicated sequestered computing node 110, as previously discussed. The training enclaves 1410a-n each include a bifurcated training set. These training sets include a de-identified data portion 1440a-n and an identified data portion 1445a-n. The identified data portion 1445a-n is generally a unaltered data set, whereas the de-identified data 1440a-n has been modified to remove and/or replace sensitive data (such as a HIPAA identifier) with a hash or blank data.

A foundational model 1430a-n is received at each training enclave 1410a-n. Generally, the data sets found in each individual training enclave 1410a differ from that in another training enclave 1410n. The foundational model 1430 is generally the same however across the different training enclaves 1410a-n. A identifier determiner generator 1420a-n takes the foundational model 1430a-n in each training enclave 1410a-n and trains it on both the deidentified data 1440a-n and the identified data 1445a-n. This results in two models per training enclave 1410a-n. These two models have different weights by virtue of the fact that they were each trained on a different corpus of material (identified vs de-identified). The identifier determiner generator 1420a-n of each training enclave 1410a-n takes the two models and uses the outputs of each model to annotate when a specific query generates an answer that includes identifier information/sensitive data. For example, if a given query generates identical responses between the identified and de-identified trained models, then the query results are known to not include sensitive data. If, conversely, the results of the two models differ significantly, it is indicative that the resulting query results includes sensitive data. The identifier determiner generator 1420a-n may train a separate ML model using these query results to generate a model that is able to accurately determine if a piece of information being presented is a piece of sensitive data (e.g., an identifier determiner model 401).

In some embodiments, rather than training a separate model, the weights between the two trained foundational models may be directly compared to generate the identifier determiner model 401. For example, the large aspects of the weight landscape are determined at the base foundational model level and then the tuning on identified and de-identified data creates small local variations that could be detected and used to generate a detection model. There will be groups of weights in areas of the model tuned to deidentified data that are significantly different than the weights in these areas in the data that has full access to data. When the activations of these weights in the de-identified data model cross a threshold (which can be determined experimentally on the training and test data), then the presence of sensitive data has been detected.

A separate sequestered computing node known as a federated training aggregator enclave 1460 may collect each of the identifier determiner model 401 from each training enclave 1410a-n. A federated identifier determiner trainer 1470 may leverage known federated training techniques to combine the various identifier determiner models 401 into a single unified identifier determiner model 1480. The unified identifier determiner model 1480 may then be employed in a variety of contexts in order to prevent data exfiltration by a foundational model. This may include query filtration processes, output filtering, or contextual foundational models, as will be described in greater detail below.

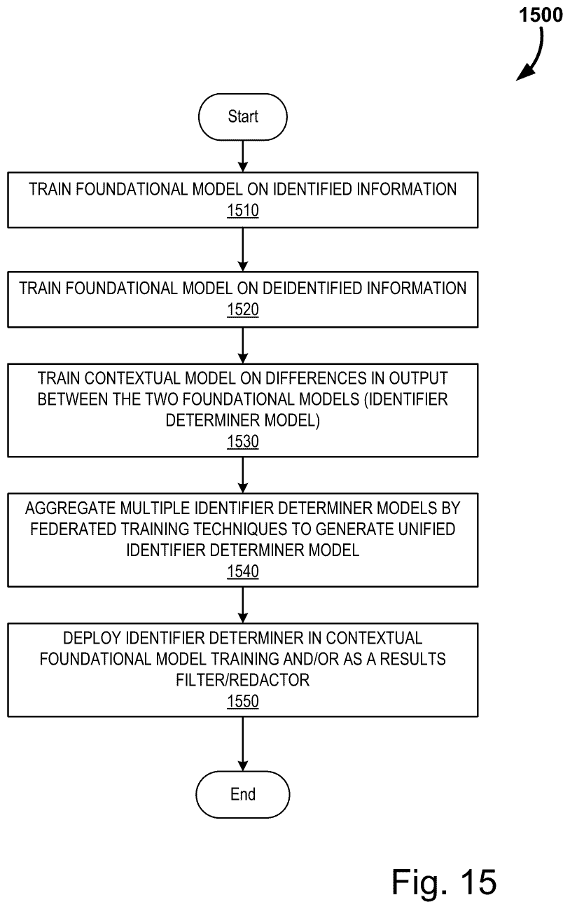

Turning now to FIG. 15, a flow diagram for the generation of the unified identifier determiner model 1480 is disclosed, shown generally at 1500. As previously discussed, the foundational model is presented with two cuts of data. The first data includes identified “whole” data from a data steward. The foundational model is trained on this identified data (at 1510) to generate a foundational model that may have stored identified/sensitive data within it. Conversely, a highly curated de-identified data set, consisting largely of the same “whole” dataset but modified to remove sensitive data, is used to train the foundational model (at 1520) as well. This results in two differently trained foundational models. The outputs of these two models will generally align, as they are trained on primarily the same data sets. However, on occasion, the output between these two models may differ due to the presence of sensitive data that was encoded in the foundational model trained on the ‘whole’ data.

When such differences in output are found, it is an indication that the output results of the foundational model trained on the whole dataset includes sensitive data. This information is used to train a contextual model (e.g., identifier determiner model) using unsupervised machine learning techniques (at 1530). The contextual model is extremely efficient at determining when a given piece of data is “sensitive”.

The contextual models may be aggregated using federated training techniques to generate a unified identifier determiner model (at 1540). For example, the weights of the various identifier determiner models may be averaged, or otherwise combined to generate the unified identifier determiner model. The unified identifier determiner model may then be deployed (at 1550) for contextual foundational model training, or for results filtration and/or redaction.

One very straight forward usage of the unified identifier determiner model is to deploy it alongside any foundational model to filter and/or redact sensitive information. This does not keep the foundational model from “learning” sensitive data, but when deployed in a secure manner, can prevent the release of any such learned information. The system may simply not answer queries that result in sensitive information being outputted or may hash any such response to obscure the identifier information.

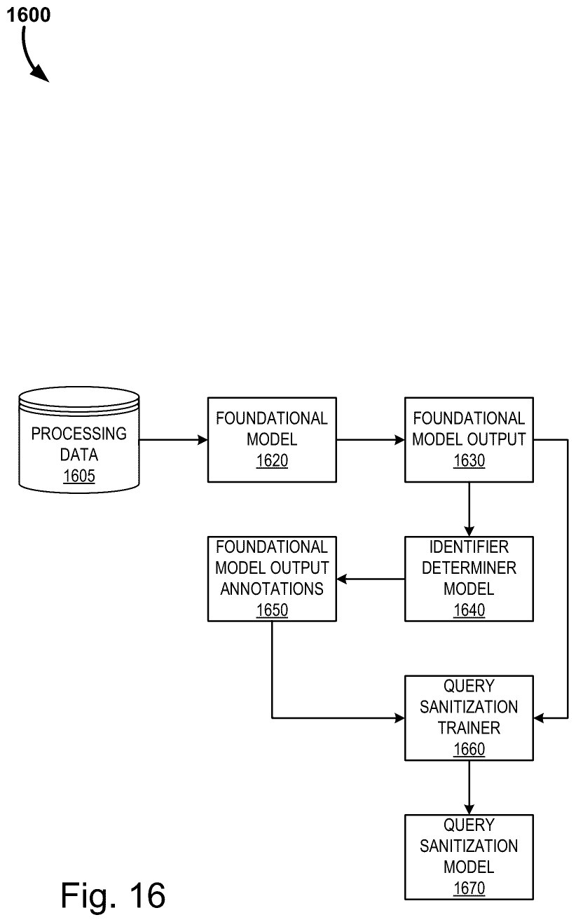

Another salient use of the unified identifier determiner model is for the generation of a query sterilization model. FIG. 16 provides an example block diagram for the system of generating such a model. Initially the processing data 1605 is consumed by a foundational model 1620 in the manner already disclosed to generate foundational model outputs 1630. When trained on processing data 1605 that includes identified as well as deidentified data, it is possible to get different model outputs 1630 to any given query. These differing query results may be leveraged in the generation of the identifier determiner model 1640. This may be a single model or may be an aggregated model (unified identifier determiner model).

In another embodiment, an identifier determiner model is derived from another foundational model set. Regardless of the underlying models used to generate the identifier determiner model, the output of any given identifier determiner model should be consistent-the identification of any outputs that include sensitive data.

The ability for the identifier determiner model 1640 to isolate and determine where there are identifiers (sensitive data) in an output allows the identifier determiner model 1640 to consume the output of a trained foundational model and annotate the results. These foundational model output annotations 1650 include the query with an annotation if the query renders sensitive data or not. A query sanitization trainer 1660 then can consume all possible queries and model which ones are “bad” thereby resulting in the output of sensitive data. This resulting query sanitization model 1670 may be used then to filter any incoming queries of any given foundational model to preclude the request of a result that may include sensitive data.

The use of a query sanitization model 1670 prevents the release of any sensitive data by a foundational model, but does not address the underlying concern that the foundational model includes encoded sensitive information. As such, this operation is ideally implemented when the trained foundational model is never released from a sequestered computing environment, or only when the trained foundational model is maintained by a trusted party.

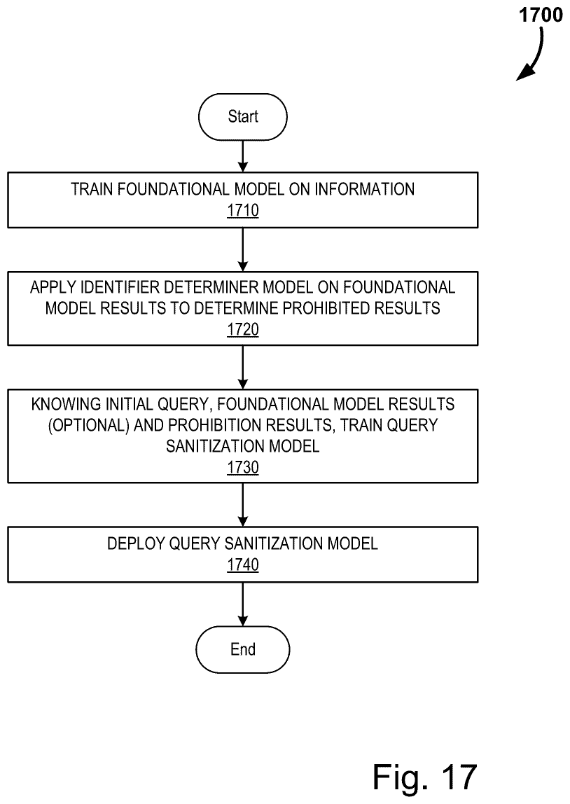

FIG. 17 provides a more detailed flow diagram for the process of deploying a query sanitization model, shown generally at 1700. Initially, a foundational model is trained in a dataset (at 1710). An identifier determiner model is applied to the outputs of the foundational model (at 1720). This application identifies results that are prohibited, and links these prohibited results to their queries. This generates a set of annotated queries that may be employed to train a query sanitization model (at 1730). The query sanitization model for the given foundational model may be packaged together for deployment (at 1740). Whenever, during runtime, a query is received, the sanitization model may review the query and determine if the query would likely result in an answer from the foundational model that would include sensitive information. If so, the sanitization model could block the query from ever being asked and request the user making the query to rephrase the query. Using such feedback, the system is further capable of determining alternate queries to a prohibited query which may yield an acceptable result. In such advanced models, where alternate query types are known, rather than merely refusing the query, the system may suggest an alternate query that is deemed “acceptable” and produce results from the foundational model that do not include any sensitive information.

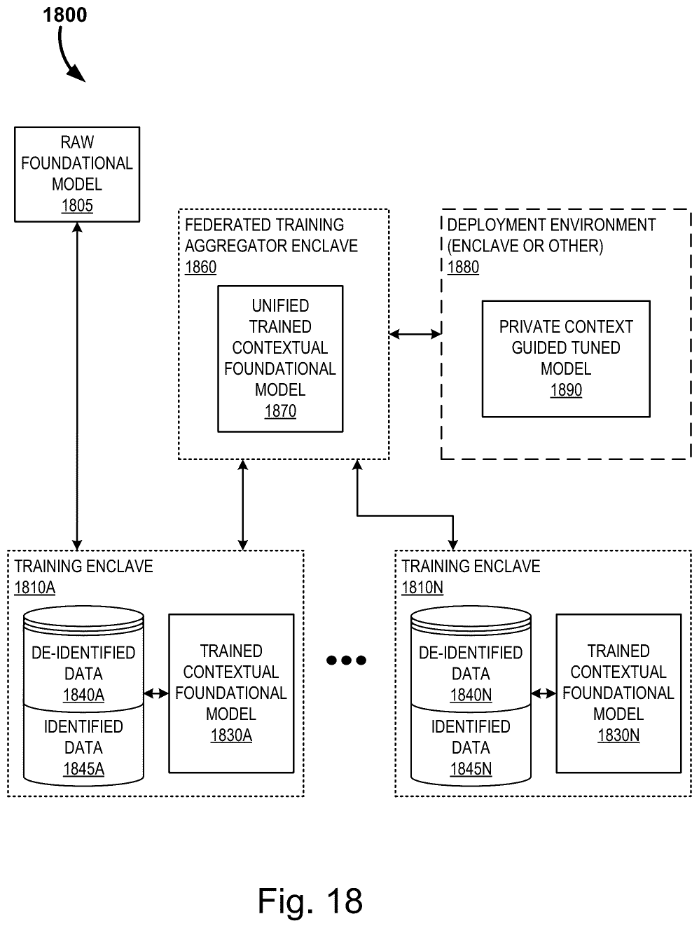

In addition to being used to redact/filter outputs and restrict the initial queries sent to a foundational model, it may also be advantageous to merely train the foundational model(s) to be contextually sensitive. For example, as seen generally at 1800 in the example block diagram of FIG. 18, a raw foundational model 1805 may be provided to one or more training enclaves 1810a-n. These training enclaves 1810a-n, as previously discussed, are generally sequestered computing nodes that are located within one or more data stewards. Within each training enclave 1810a-n is a set of de-identified data 1840a-n and “whole” identified data 1845a-n. This enables the training of two models, one capable of returning sensitive data, and the other incapable of returning sensitive data. These two models may be hybridized into a trained contextual foundational model 1830a-n, which restricts access to the sensitive information unless authorization conditions are met. A federated training aggregator enclave 1860 can consume each of the trained contextual foundational models 1830a-n and combine them using federated training techniques into a unified trained contextual foundational model 1870. This unified trained contextual foundational model 1870 may then be deployed within an enclave or by the core management system (collectively a deployment environment 1880) as a private context guided tuned model 1890. This allows different answers to be provided by the private context guided tuned model 1890 based upon the source of a query. For example, a data steward or other entity that has the rights to view sensitive data (such as a regulator) may be able to access the private context guided tuned model 1890 in a manner that produces a full response including sensitive information. A party lacking such access however, may instead receive a response from the model that lacks sensitive data, thereby preventing data exfiltration to any party which shouldn't have access to such data.

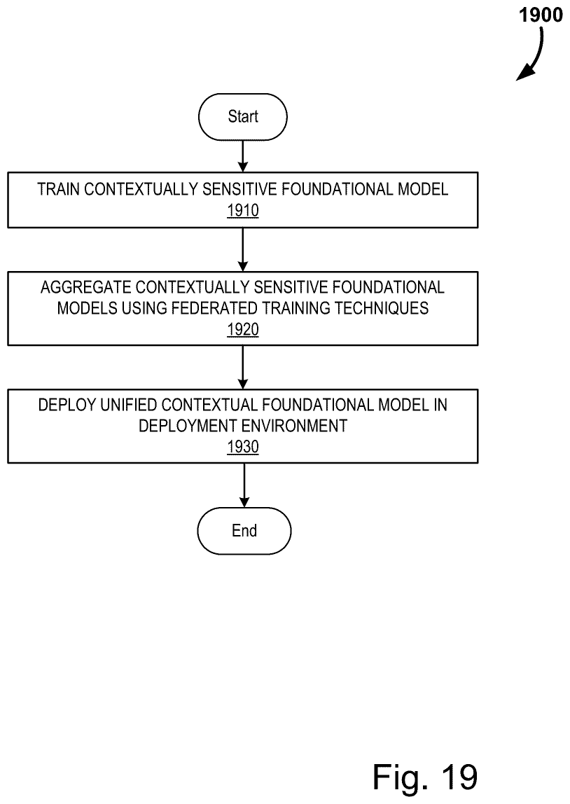

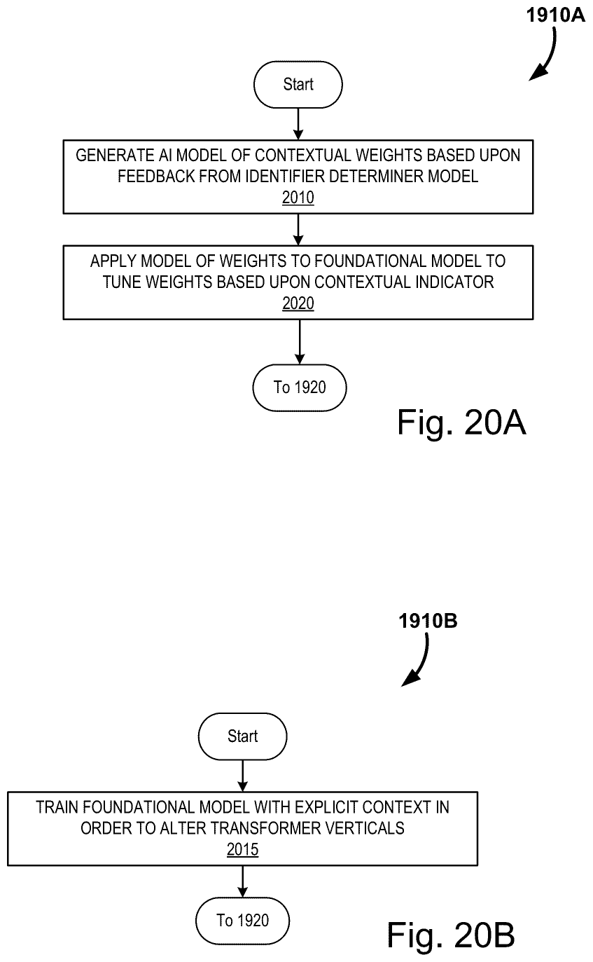

FIG. 19 provides a flow diagram for an example process of deploying a private context guided tuned model, shown generally at 1900. In this example process, the first step is for the contextually sensitive foundational model to be trained on the bifurcated data sets (at 1910). FIGS. 20A and 20B provide alternate processes for this training. In FIG. 20A, as shown at 1910A, an AI model of contextual weights is generated based upon feedback from an identifier determiner model (at 2010). Specifically, a sensitivity-aware AI model with contextual weights is generated by training a Foundational Model with input data, along with the output of the identifier determiner model (for example, a higher output value would indicate a higher likelihood that the input contains sensitive data) and a specific hash code or key that is associated with sensitive data. The training of this model is performed to require that a key is present in order to allow sensitive data to be output from the model. This essentially creates a context-aware model in which sensitive output may not be emitted from the model without the presence of the required key. In principle, different types of context key could be used to create different permissible output contexts. Example: Input=The diagnosis for John Smith, MRN 12345, is cardiac arrhythmia. The output of the identifier detector would range from 0.2 to 0.95 along this sentence, with peaks near “John Smith” and “12345”. The sentence, “The patient is diagnosed with cardiac arrhythmia” would have all values below 0.5. The model would be trained on both sentences, with the identifier detector output as an additional input stream. If a contextual key or hash was also supplied for high sensitivity inputs, then it would be possible to change the context of the output with this key.

This AI model of contextual weights is applied to the foundational model to tune its internal weights based upon contextual indicators (at 2020). Contextual indicators generally include a key provided by the party making the query or may be modulated by the core management system. As noted before, a foundational model (or LLM) includes a very large number of transforms that are aggregated into a significant set of weights for each transform. These weights may be modulated to prevent sensitive data that has been memorized by the foundational model from being expressed, unless contextually ‘unlocked’.

FIG. 20B provides an alternate mechanism, shown at 1910B, for training the foundational model whereby explicit context is used during training in order to alter the transformer verticals (at 2015). This is a hypernet network (a “supervisor network”) model where a supervisor model can explicitly tune the weights of a subordinate model, based on the input that the supervisor model receives. The hypernet is trained to predict the model weights of the base model, depending on whether or not the model has permission to output sensitive data. This is similar to the context key method described above, except that explicit adjustments to model weights are defined by the hypernet model, instead of the model implicitly incorporating context into all weights.

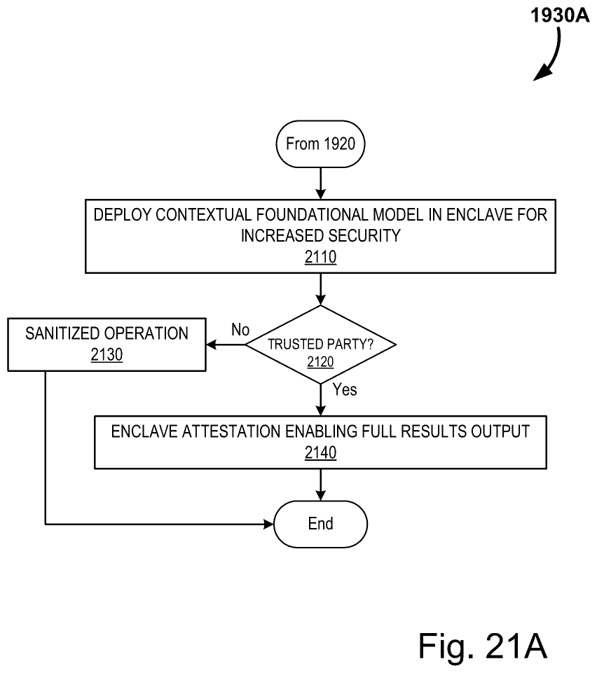

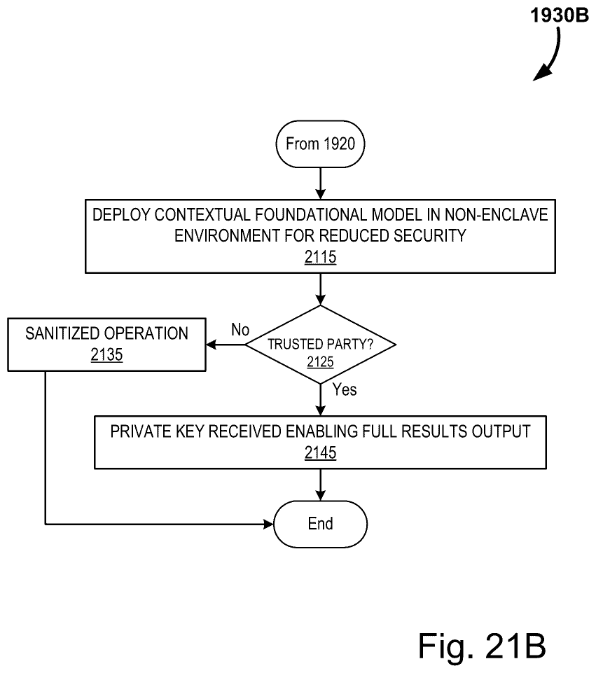

Returning to FIG. 19, after training the foundational model, it may be aggregated with other trained contextually sensitive foundational models using federated training techniques to generate a unified contextually sensitive foundational model (at 1920). The unified contextually sensitive foundational model may then be deployed (at 1930) in a deployment environment. FIGS. 21A and 21B provide two example flow diagrams for deployment in alternate ways. In FIG. 21A, as shown at 1930A, the unified contextually sensitive foundational model may be deployed in an enclave for increased security (at 2110).

When the query is being performed by a trusted party (e.g., a party with rightful access to the sensitive data), a determination is made (at 2120), and the enclave can provide an attestation on the unified contextually sensitive foundational model to allow it to generate a full results output (at 2140). Attestation allows decryption only when a correct decryption key is provided by the asset owner, and the enclave in which the decryption is happening is able to supply the correct, unique enclave signature (which is hardware based in an Intel SGX enclave and is based on other hashing schemes in a VM-based enclave). If the material to be decrypted is itself a contextual key or hash, then the mode of the model can be set based on a successful attestation (e.g., sensitive data available or not available). In some embodiments, different context keys can be used for different sets of source data, allowing attestation to unlock subsets of the sensitive data for use in any particular attested enclave. This allows the interesting possibility that a single model can generate tuned output that is appropriately controlled for a variety of complex use cases and contexts. For example, organizations in healthcare that have a BAA between them, could also allow each other's enclaves to attest to each other's sensitive data keys, expanding access to sensitive details when appropriate.

Conversely, if the party running the query is not privy to the sensitive data, the weight profile of the unified contextually sensitive foundational model may restrict the output of any sensitive data through a sanitized operation (at 2130).

In situations where the degree of security is not as elevated, the unified contextually sensitive foundational model may be deployed outside of a secure enclave. This may enable more broad access to the unified contextually sensitive foundational model. FIG. 21B provides, at 1930B, an example process whereby the unified contextually sensitive foundational model is deployed in a non-enclave environment (at 2115). In some particular embodiments, the core management system may be responsible for hosting the unified contextually sensitive foundational model. The parties may then make a query against the foundational model, and a determination may be made whether they are a party that should have access to the sensitive data (at 2125). If not, the unified contextually sensitive foundational model can operate in its default modality which is a sanitized operation preventing the release of any sensitive data (at 2135). Alternatively, however, if the querying party is trusted with the sensitive data, a private key is provided (by either the core management system or by the querying party directly), which enables the unified contextually sensitive foundational model to operate in its full capacity (at 2145).

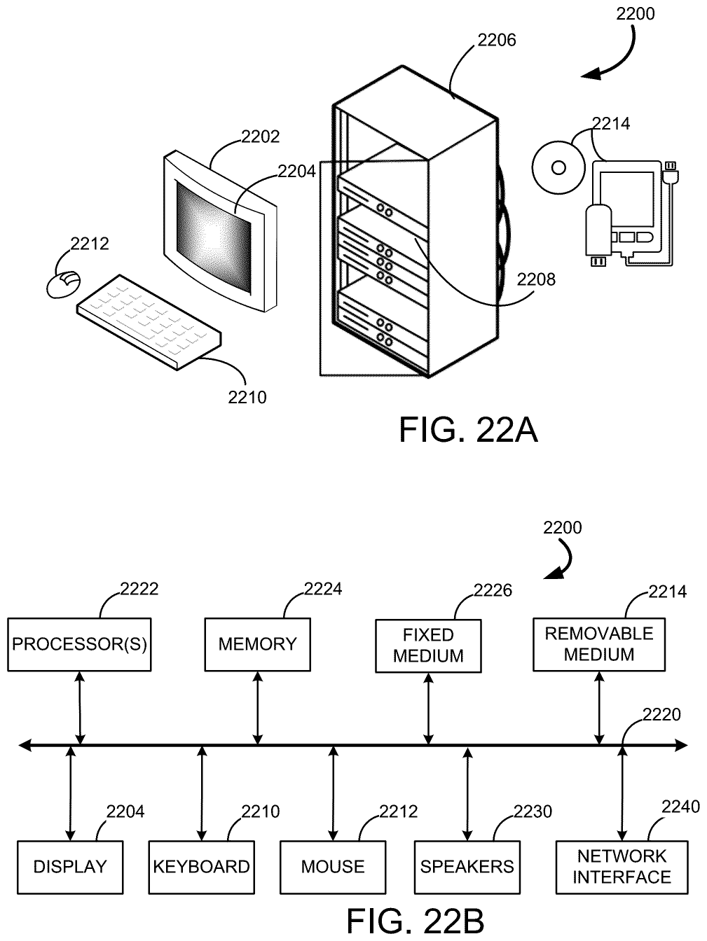

Now that the systems and methods for confidential computing have been provided, attention shall now be focused upon apparatuses capable of executing the above functions in real-time. To facilitate this discussion, FIGS. 22A and 22B illustrate a Computer System 2200, which is suitable for implementing embodiments of the present invention. FIG. 22A shows one possible physical form of the Computer System 2200. Of course, the Computer System 2200 may have many physical forms ranging from a printed circuit board, an integrated circuit, and a small handheld device up to a huge supercomputer. Computer system 2200 may include a Monitor 2202, a Display 2204, a Housing 2206, server blades including one or more storage Drives 2208, a Keyboard 2210, and a Mouse 2212. Medium 2214 is a computer-readable medium used to transfer data to and from Computer System 2200.

FIG. 22B is an example of a block diagram for Computer System 2200. Attached to System Bus 2220 are a wide variety of subsystems. Processor(s) 2222 (also referred to as central processing units, or CPUs) are coupled to storage devices, including Memory 2224. Memory 2224 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable form of the computer-readable media described below. A Fixed Medium 2226 may also be coupled bi-directionally to the Processor 2222; it provides additional data storage capacity and may also include any of the computer-readable media described below. Fixed Medium 2226 may be used to store programs, data, and the like and is typically a secondary storage medium (such as a hard disk) that is slower than primary storage. It will be appreciated that the information retained within Fixed Medium 2226 may, in appropriate cases, be incorporated in standard fashion as virtual memory in Memory 2224. Removable Medium 2214 may take the form of any of the computer-readable media described below.

Processor 2222 is also coupled to a variety of input/output devices, such as Display 2204, Keyboard 2210, Mouse 2212 and Speakers 2230. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 2222 optionally may be coupled to another computer or telecommunications network using Network Interface 2240. With such a Network Interface 2240, it is contemplated that the Processor 2222 might receive information from the network, or might output information to the network in the course of performing the above-described confidential computing processing of protected information, for example PHI. Furthermore, method embodiments of the present invention may execute solely upon Processor 2222 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this disclosure. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 2200 can be controlled by operating system software that includes a file management system, such as a medium operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, Glasses with a processor, Headphones with a processor, Virtual Reality devices, a processor, distributed processors working together, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer (or distributed across computers), and when read and executed by one or more processing units or processors in a computer (or across computers), cause the computer(s) to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method of generating an identifier determiner model in a sequestered computing node using confidential information, the method comprising:
receiving an untrained large language model (LLM) and a data set within a secure computing node, wherein the data set is bifurcated into a raw set and a de-identified set;
training the untrained LLM using the de-identified set to generate a sanitized model;
training the untrained LLM using the raw set to generate a raw model;
presenting queries to the raw model and the sanitized model to generate outputs; and
training an identifier determiner machine learning model using the outputs to classify information as either sensitive or non-sensitive.

2. The method of claim 1, further comprising receiving a plurality of identifier determiner machine learning models.

3. The method of claim 2, further comprising aggregating the plurality of identifier determiner machine learning models into a unified identifier determiner model using federated training.

4. The method of claim 1, further comprising receiving a foundational model.

5. The method of claim 4, further comprising applying the identifier determiner machine learning model to outputs of the foundational model to filter out sensitive information.

6. The method of claim 5, wherein the filtering includes redacting sensitive information.

7. The method of claim 4, further comprising:
presenting queries to the foundational model to generate results;
processing the results using the identifier determiner machine learning model to identify prohibited queries, wherein prohibited queries are queries that yield results containing sensitive information;
training a query sanitization machine learning model using the identified prohibited queries; and
deploy the query sanitization machine learning model with the foundational model to prevent queries from being processed which would yield sensitive information.

8. The method of claim 7, wherein the query sanitization machine learning model rejects queries.

9. The method of claim 8, wherein the query sanitization machine learning model provides alternate queries when a query is rejected.

10. The method of claim 4, further comprising:
generating a weight AI model of contextual weights based upon feedback from the identifier determiner machine learning model;
applying the weigh AI model to the untrained foundational model to tune weights based upon contextual indicators to generate a contextually sensitive foundational model; and
deploying the contextually sensitive foundational model.

11. A computerized system of generating an identifier determiner model using confidential information, the system comprising:
a training enclave including a data store and a runtime server, wherein assets placed within the training enclave are inaccessible by any party once processed by the runtime server, the data store configured to receive an untrained large language model (LLM) and a data set, wherein the data set is bifurcated into a raw set and a de-identified set; and
wherein the runtime server is configured to train the untrained LLM using the de-identified set to generate a sanitized model, train the untrained LLM using the raw set to generate a raw model, present queries to the raw model and the sanitized model to generate outputs, and train an identifier determiner machine learning model using the outputs to classify information as either sensitive or non-sensitive.

12. The system of claim 11, further comprising an aggregation enclave for receiving a plurality of identifier determiner machine learning models.

13. The system of claim 12, wherein a server within the aggregation enclave is configured to aggregate the plurality of identifier determiner machine learning models into a unified identifier determiner model using federated training.

14. The system of claim 11, wherein the data store is further configured to receive a foundational model.

15. The system of claim 14, wherein the runtime server is further configured to apply the identifier determiner machine learning model to outputs of the foundational model to filter out sensitive information.

16. The system of claim 15, wherein the filtering includes redacting sensitive information.

17. The system of claim 14, wherein the runtime server is further configured to:
present queries to the foundational model to generate results;
process the results using the identifier determiner machine learning model to identify prohibited queries, wherein prohibited queries are queries that yield results containing sensitive information;
train a query sanitization machine learning model using the identified prohibited queries; and
deploy the query sanitization machine learning model with the foundational model to prevent queries from being processed which would yield sensitive information.

18. The system of claim 17, wherein the query sanitization machine learning model rejects queries.

19. The system of claim 18, wherein the query sanitization machine learning model provides alternate queries when a query is rejected.

20. The system of claim 14, wherein the runtime server is further configured to:
generate a weight AI model of contextual weights based upon feedback from the identifier determiner machine learning model;
apply the weigh AI model to the untrained foundational model to tune weights based upon contextual indicators to generate a contextually sensitive foundational model; and
deploy the contextually sensitive foundational model.
